(19) United States
(12) Patent Application Publication
(10) Pub. No.: US 2023/0101047 A1
(43) Pub. Date: Mar. 30, 2023

(54) A JOINT EMBODIMENT IN DRIVESHAFT

(71) Applicant: TIRSAN KARDAN SANAYI VE TICARET ANONIM SIRKETI, Yunusemre, Manisa (TR)

(72) Inventors: Korkut TASAN, Yunusemre, Manisa (TR); Huseyin OZGURLER, Yunusemre, Manisa (TR); Sebahattin DAVAZLI, Yunusemre, Manisa (TR)

(21) Appl. No.: 17/053,033

(22) PCT Filed: Jun. 8, 2020
(86) PCT No.: PCT/TR2020/050496

§ 371 Date: Nov. 4, 2020

(30) Foreign Application Priority Data
Aug. 1, 2019 (TR) 2019/11623

(51) Int. Cl. F16D 3/38; F16D 3/40

(52) U.S. Cl. CPC F16D 3/385; F16D 3/40

(57) ABSTRACT

Disclosed is a driveshaft joint embodiment providing increase of driveshaft joint strength and longer life by keeping the rotational diameter fixed and providing placement under the vehicle in dimensional terms subject to the rotation diameter thanks to the embodiment provided on the driveshaft joint.

### TECHNICAL FIELD

Invention relates to driveshaft joint embodiment providing increase of driveshaft joint strength and longer life by keeping rotation diameter fixed and providing placement under vehicle in dimensional terms subject to rotation diameter, thanks to embodiment provided on the driveshaft joint in general.

### BACKGROUND OF THE INVENTION

Today driveshafts are torque transmitting parts on vehicles and transmit torque received from engine or gearbox to differential or other equipment needing it by rotational motion. In addition to transmission of torque driveshaft can also perform axial (vertical) and angular motion in order to compensate axis motion affected by road conditions.

In the related art driveshaft comprises singular parts of various characteristics. The parts enable driveshaft to conduct vertical and angular compensation. The parts enable driveshaft to conduct vertical and angular compensation. The biggest factor in placement of driveshaft under the vehicle is rotational diameter and refers to the widest volume moved by driveshaft joint.

Angular compensation is provided by driveshaft joint in the related art. Joint comprises two-ear part and complete cross providing connection between the two-ear part. Complete cross comprises universal joint body and bearings providing housing of cross to ear parts.

In practice, driveshaft can transmit the maximum rotational moment generated by transmission parts to wheels. Driveshaft is subject to loads of varying magnitude and periods. During service life driveshaft is expected to perform all functions without any breaking, wearing in complete of it and/or subcomponent parts. In addition, although vehicle torque values increase, it is desired to not increase but decrease complete vehicle weight in the market. Maximum torque value transmittable by complete driveshaft per unit weight is referred to as power intensity (N.m / Kg) and said invention also relates to increasing complete driveshaft power intensity.

In addition to driveshaft, there are also other components serving various functions of vehicle in respect to placement under the vehicles. For that reason, there is a limited space under vehicle for placement of driveshaft. This space creates a dimensional restriction for driveshaft design.

Strength against varying loading conditions can be increased by use of a next top driveshaft platform. However, in such case the increasing cross arm size negatively affects and increases rotational diameter which is a dimensional restriction in driveshaft design. However, in such case the increasing cross arm size negatively affects and increases rotational diameter which is a dimensional restriction in driveshaft design.

As a result, new embodiments eliminating the above disadvantages of driveshaft joints and offering solutions to existing systems are needed.

### DESCRIPTION OF THE INVENTION

The present invention relates to driveshaft joint embodiment meeting the needs mentioned above, eliminating all disadvantages and providing some additional advantages.

Primary purpose of the invention is to provide a solution in the form of increasing universal joint bearing diameter and yoke parts ear diameter instead of increasing strength of driveshaft against varying loading conditions and increasing cross arm size due to rotational diameter restriction for providing placement under vehicle while performing increasing operation.

Another purpose of the invention is to provide a new embodiment in driveshaft joint already in use instead of using a next upper (bigger) driveshaft platform.

A further purpose of the invention is also to provide making weight of driveshaft lighter by providing a new embodiment in driveshaft joint.

Another purpose of the invention is to eliminate problem of placement under vehicle without changing rotational diameter and also increase variable load carrying capacity.

The structural and characteristic features and all advantages of the invention will be understood better in the figures given below and the detailed description by reference to the figures. Therefore, the assessment should be made based on the figures and taking into account the detailed descriptions.

### BRIEF DESCRIPTION OF THE DRAWINGS

In order to make the embodiment and additional members being subject of the present invention as well as the advantages clearer for better understanding, it should be assessed with reference to the fallowing described figures.

FIG. 1 is a perspective view of demounted status of driveshaft joint embodiment of the invention.

FIG. 2 is a detailed view of driveshaft joint embodiment of the invention.

FIG. 3 is a side two-dimension view of axis size of driveshaft joint embodiment disclosed under the invention.

FIG. 4 is a side two-dimension view of joint angle of driveshaft joint embodiment disclosed under the invention.

### REFERENCE NUMBERS

100-Driveshaft joint embodiment
101-Driveshaft
102- Primary yoke part
103-Secondary yoke part
104- Universal joint body
105-Universal joint bearing
105.1-Universal joint bearing diameter
106-Rotational diameter
107-Ear hole diameter
108-Universal joint body full length
109-Axis size
110-Joint angle
Detail A - detail A

### DETAILED DESCRIPTION OF THE INVENTION

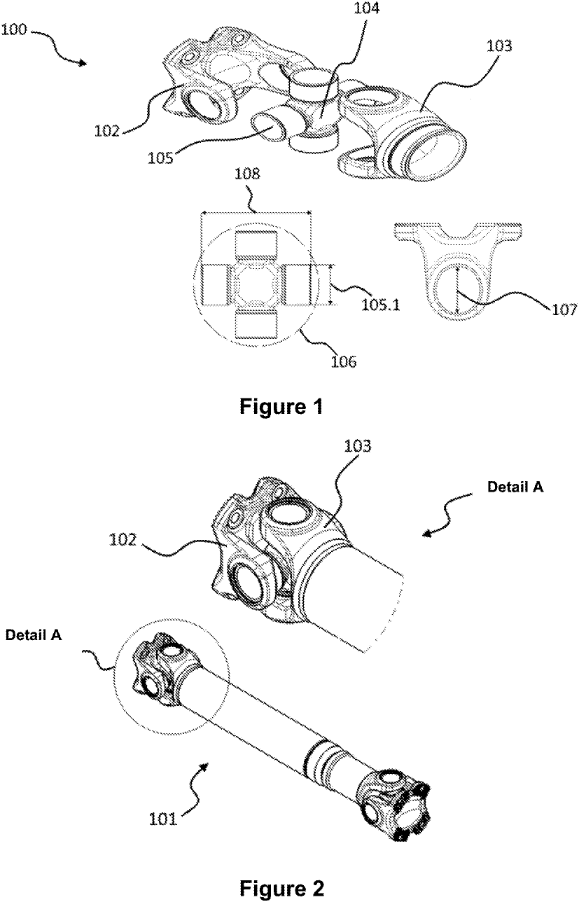

FIG. 1 shows a perspective view of demounted status of driveshaft joint embodiment (100) of the invention. The invention proposes solution in the form of increasing universal joint bearing diameter (105.1) and yoke parts (102, 103) ear diameter (107) instead of increasing strength of driveshaft (101) against varying loading conditions and increasing cross body (104) arm size due to rotational diameter (106) restriction for providing placement under vehicle while performing increasing operation.

FIG. 2 shows a perspective view of detail A (Detail-A) of driveshaft joint embodiment (100) of the invention. Driveshaft (101) comprises a primary yoke part (102) and a secondary yoke part (103) functioning as connection member and housing universal joint body (104) and angle compensation. Said universal joint body (104) hosts on four arms the universal joint bearings (105) providing angular compensation on driveshaft (101). Said universal joint bearings (105) are housed to universal joint body (104) on driveshaft (101) and provide both angular compensation and interconnection of yoke parts (102,103).

Universal joint bearing diameter (105.1) is increased in order to keep rotational diameter (106) at driveshaft (101) fixed and provide increase in variable load carrying capacity coming onto driveshaft joint embodiment (100). Ear hole diameters (107) of primary yoke part (102) and secondary yoke part (103) are also increased based on increased universal joint bearing diameter (105.1). Thus it is provided to house universal joint bearing (105) and increase carrying capacity of variable load coming onto driveshaft joint embodiment (100).

In an embodiment of the invention, while universal joint bearing diameter (105.1) is increased by 4% in comparison to current related art, rotational diameter (106) remains fixed Thus keeping rotational diameter (106) fixed and increasing universal joint bearing diameter (105.1) and accordingly ear hole diameter (107) provide increase in dynamic load carrying capacity.

With driveshaft joint embodiment (100) of the invention, problem of placement under vehicle is eliminated without changing rotational diameter (106) and also variable load carrying capacity is increased.

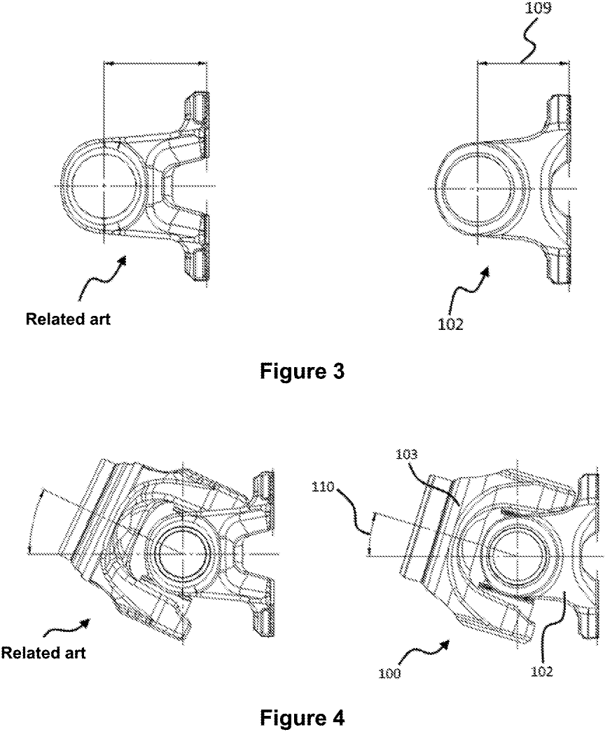

FIG. 3 shows a two-dimension view displaying axial size (109) of driveshaft joint embodiment (100) of present related art on the left and of the invention on the right. With driveshaft joint embodiment (100) of the invention axis size (109) is decreased in comparison to present related art driveshaft. As a result of decrease in axis size (109) weight is also decreased.

FIG. 4 shows a two-dimension view displaying joint angle (110) of driveshaft joint embodiment (100) of present related art on the left and of the invention on the right. Joint angle (110) is decreased in driveshaft joint embodiment (100) of the invention. For instance, while joints used in the present related art have an angle of 25 degrees, the joint angle (110) of driveshaft joint embodiment (100) of the invention is 17 degrees. A decrease of 32% in joint angle (110) provides decrease in weight of driveshaft in the amount of 4.16-6.33 kg. Such weight decrease not only provides efficient use of sources, increase in fuel oil efficiency, decrease in environmental pollution but also decrease in production cost.

1. In order to solve problem ofplacement under vehicle without changing rotational angle and also provide increase in variable load carrying capacity, a driveshaft joint embodiment comprising:
a universal joint body functioning as a connection member in a driveshaft;
a primary yoke part and a secondary yoke part housing said universal joint body and providing angle compensation;
a universal joint bearing housed on four arms of the universal joint body and providing both angle compensation and interconnection of the yoke parts and characterized in comprising;
auniversal joint bearing diameter increased in order to keep rotational diameter at driveshaft fixed and provide increase in variable load carrying capacity coming onto driveshaft joint; and
increased ear hole diameter to provide housing of universal joint bearing increase in variable load carrying capacity to driveshaft joint.

2. The driveshaft joint embodiment according to claim 1, comprising universal joint bearing diameter keeping rotational diameter fixed and increasing at rate of 4%.
